(19) United States
(12) Patent Application Publication
(10) Pub. No.: US 2007/0100128 A1
(43) Pub. Date: May 3, 2007

(54) Segmented poly(ethyleneimine) compositions

(75) Inventor: David B. Bailey, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/262,228

(22) Filed: Oct. 28, 2005

(51) Int. Cl. C08G 69/08

(52) U.S. Cl. 528/310

(57) ABSTRACT

A polymer represented by either Structure I or Structure II:
X [symbol] (NHCH₂CH₂)ₘ-Lᵣ-B]_{S} Structure I wherein m is independently 2 to 500; X is an initiating group; B is independently a polymer or copolymer segment, wherein B is not poly(2-ethyloxazoline) (PEO) if its molecular weight is greater than 2,500 and B is connected to the PEI segment (NHCH2CH2)m either directly (r=0) at the end of the chain or via a linking group (r=1) at the end of the chain; L is independently a linking group; r is 0 or 1; and
s is 1 to 8; 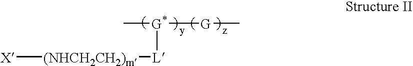 wherein m′ is independently 2 to 500; X′ is independently an initiating group L′ is independently a linking group linking the end of the chain of the PEI segment (NHCH2CH2)m′ to G*; G is independently a polymerizable monomer; G* is a monomer unit that is copolymerizable with the G monomer; y+z is from 10 to 100,000; and 0<y/z<=1.

### FIELD OF THE INVENTION

The present invention relates to new compositions containing discreet segments of poly(ethyleneimine)

### BACKGROUND OF THE INVENTION

Copolymers are used in many complex applications wherein multiple requirements come into conflict with each other. Where requirements are not in conflict, copolymer composition adjustments are well suited for tuning to intermediate properties. However, in applications where properties are at odds, compositional adjustments intended to enhance one property may be to the detriment of the other leading to a net loss in performance. Adhesives, for example, are designed to interact strongly with two surfaces often of very different affinities. A copolymer that contains elements of each would behave as an average of the two and satisfy neither. In similar fashion, an aqueous dispersant has to interact with a water insoluble surface and at the same time be able to present a hydrophilic domain to the water phase. The concepts of crosslinking and solubilization are as opposed as two properties can be. Yet both of these functions must coexist in a single polymer chain if the goal is to create a microgel particle wherein the core is crosslinked and the surface is covered with solubilizing arms. Without segregation of the crosslinking sites from the solubilizing arms, the result would be an insoluble mass. Therefore, there are many applications where it is essential to separate different elements into different domains of a polymer chain such that each can maintain its uniqueness. This objective has been achieved and widely reported in the context of block, graft and segmented copolymers of assorted architectures ranging from simple A-B block to multiple blocks, stars and grafts.

Polyethyleneimine (PEI) is a highly versatile material that could have even broader applications if available in segmented form. PEI is reactive, hydrophilic, can be ionic or neutral, is able to complex metals, and associates well with acidic surfaces and particles. Numerous publications and patents attest to its versatility. Although PEI has been used as a component of many copolymers, these are unfortunately not in segmented form. For example, partial hydrolysis of poly(2-alkyloxazoline) copolymers would create individual PEI units but they would be at random points along the chain.

Attempts to create PEI in a segmented architecture have failed or are greatly limited in scope. EP0473088 describes a graft copolymer where non PEI chains are attached to a PEI core. The intent was to create a highly branched structure using PEI as the hub. The PEI units are consumed in the process creating an interesting architecture but one that no longer has a PEI moiety. USP2004/0054127 achieves a block poly(ethyleneimine)-poly(2-ethyloxazoline) copolymer by a two phase selective hydrolysis of block poly(2-methyloxazoline)-poly(2-ethyloxazoline) copolymer. This approach was limited to poly(2-ethyloxazoline) as the second block and does not allow for poly(2-methyloxazoline) or poly(oxazoline) in combination with poly(ethyleneimine). Therefore, the need for a broad range of segmented copolymers wherein one of the segments is PEI remains largely unfulfilled

### SUMMARY OF THE INVENTION

This invention provides a polymer represented by either Structure I or Structure II:
X [symbol] (NHCH₂CH₂)ₘ-Lᵣ-B]_{S} Structure I
wherein m is independently 2 to 500;
X is an initiating group;
B is independently a polymer or copolymer segment, wherein B is not poly(2-ethyloxazoline) (PEO) if its molecular weight is greater than 2,500 and B is connected to the PEI segment (NHCH2CH2)m either directly (r=0) at the end of the chain or via a linking group (r=1) at the end of the chain;
L is independently a linking group;
r is 0 or 1; and
s is 1 to 8; 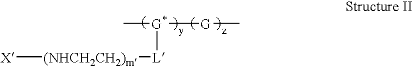
wherein m′ is independently 2 to 500;
X′ is independently an initiating group
L′ is independently a linking group connected to the end of the PEI segment (NHCH2CH2)m′
G is independently a polymerizable monomer;
G* is a monomer unit that is copolymerizable with the G monomer;
y+z is from 10 to 100,000; and
0<y/z<=1.

This invention further provides a method of preparing a polymer represented by Structure I comprising providing a precursor polymer represented by Structure III and selectively deblocking said precursor polymer by hydrolysis: 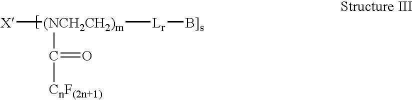
wherein m is independently 2 to 500;
X is an initiating group;
B is independently a polymer or copolymer segment, wherein B is not poly(2-ethyloxazoline) (PEO) if its molecular weight is greater than 2,500 and B is connected to the PEI segment (NHCH2CH2)m either directly (r=0) at the end of the chain or via a linking group (r=1) at the end of the chain;
L is independently a linking group;
r is 0 or 1; and
s is 1 to 8; and n is 1 to 7.

It also provides a method of preparing a polymer represented by Structure II comprising providing a precursor polymer represented by Structure IV and selectively deblocking said precursor polymer by hydrolysis 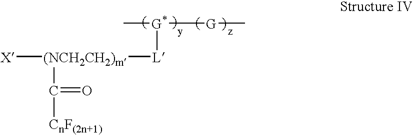
wherein m′ is independently 2 to 500;
X′ is independently an initiating group
L′ is independently a linking group linking the end of the chain of the PEI segment (NHCH2CH2)m′ to G*;
G is independently a polymerizable monomer;
G* is a monomer unit that is copolymerizable with the G monomer;
y+z is from 10 to 100,000;
0<y/z<=1; and.
n is 1 to 7.

Segmented copolymers that contain polyethyleneimine (PEI) as a separate and distinct phase offer wide potential as adsorbants, stabilizers and as reactive polymers for binding a range of addenda including dyes and pharmaceuticals.

### DETAILED DESCRIPTION OF THE INVENTION

Segmented copolymer architectures can take any of a number of forms including blocks, grafts, stars and so on. The essential feature common to all is that the two components are present in separate groupings. The separate groupings can be referred to as the individual segments. Combinations of these segments can be referred to as higher order structures such as blocks, stars, grafts, interpenetrating networks, surface functionalized particles or any combination of multiple segments. The specific description of block or grafts here is not meant to limit this invention to those particular arrangements. The architectures of this invention consist of a combination of a PEI segment or segments coupled to a non PEI segment or segments in the form of any higher order structure.

The polymers of the invention are represented by either Structure I or Structure II below. For Structure I
X [symbol] (NHCH₂CH₂)ₘ-Lᵣ-B]_{S} Structure I
the PEI segment has a degree of polymerization from 2 to 500 and preferably from 2 to 100, i.e m is independently 2 to 500, and more preferably 2 to 100. X is an initiating group that initiates polymerization of the PEI segment; preferably X is an alkyl group, a multifunctional alkyl group of functionality from 1 to 8 or a perfluoroalkyl group. s is 1 to 8, and more preferably s is 1.

B is independently a polymer or copolymer segment, wherein B is not poly(2-ethyloxazoline) (PEO) if its molecular weight is greater than 2,500. B is connected to the PEI segment (NHCH2CH2)ₘ either directly (r=0) at the end of the PEI chain or via a linking group (r=1) at the end of the PEI chain. L is independently a linking group and r is 0 or 1.

The non PEI segment (B) may be hydrophilic or hydrophobic polymer. It may be organic or inorganic and either natural or synthetic. In addition B may be in the form of a particle or attached to a surface. In one embodiment B is a vinyl polymer and L has a functionality (or group) suitable for attaching to the end of a vinyl polymerization that produces B. For example, L may have a thiol functionality suitable for attaching to the end of a vinyl polymer by chain transfer polymerizaion; a functionality suitable for “atom transfer polymerization”; a nitroxide functionality suitable for mediated polymerization; a functionality suitable for RAFT (Reversable Addition Fragmentation Transfer) polymerization or a functionality that contains multiple groups of the above.

In another embodiment wherein s is 2; B is a condensation polymer such as a polyester, polycarbonate, polyamide, polyurethane and the like and L has a functionality (or group) suitable for attaching to the end or ends of a condensation polymer. Examples of suitable groups include, but are not limited to, an amine, an epoxy, a carboxlic acid, an alcohol or a group that contains multiple groups of the above

For Structure II 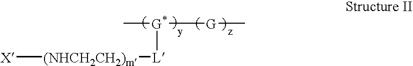
X′ is independently an initiating group as described for X above. L′ is independently a linking group connected to the end of the PEI segment (NHCH2CH2)m′. L′ is a group that connects the chain to G*. For example, L′ may be a substituted amide derived from the reaction of the chain end with an iminoether. m′ is independently 2 to 500, and more preferably 2 to 100. G is independently a polymerizable monomer and G* is a monomer unit that is copolymerizable with the G monomer. G* comprises a functionality (or group) suitable for participating in the polymerization of G such as a bisamine, a bisexpoxide, a biscarboxlic acid, a diol, a vinyl group, a cyclic group that can polymerize by ring opening, or a group that contains multiple groups of the above. Preferably G* comprises a vinyl group suitable for participating in the polymerization of G. y+z is from 10 to 100,000; and 0<y/z<=1.

This invention further provides a method of preparing a polymer represented by Structure I or Structure II. The polymer represented by Structure I is made by providing a precursor polymer represented by Structure III and selectively deblocking said precursor polymer by hydrolysis: 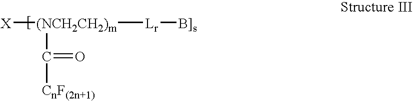
wherein m, X, B, L, r and s are as defined above and n is 1 to 7.

The polymer represented by Structure II is made by providing a precursor polymer represented by Structure IV and selectively deblocking said precursor polymer by hydrolysis: 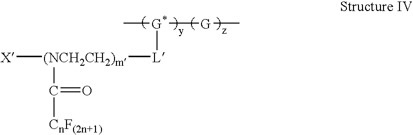
wherein m′, X′, L′, m,′ G; G*; and y+z are as defined above and n is 1 to 7.

The PEI segment of this invention is created from a perfluoro blocked precursor polymer in the form of poly(2-perfluoroalkylloxazoline) (PFO). Both 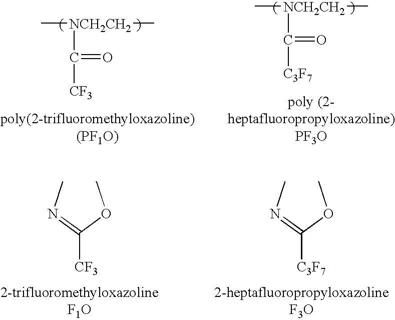
poly(2-trifluoromethyloxazoline)) (PF₁O) and poly(2-heptafluoropropyloxazoline) (PF₃O) are examples. In general, PFO is made by cationic ring opening polymerization of the corresponding oxazoline monomer (F₁O, F₃O for example) as described by M. Miyamato and K. Saegusa, Macromolecules, 1988, 21, 1880. An essential feature is that the PFO terminal group is highly reactive and is therefore available to a wide range of attachment strategies for incorporation of PFO into higher order structures. After incorporation, the PFO can be hydrolyzed under relatively mild conditions to produce the PEI segment. PFO is advantageous in this respect since the electron withdrawing character of the perfluoro group enhances the hydrolysis rate. PFO, the blocked form of PEI, is hydrophobic which greatly expands its range of incorporation. PEI on the other hand has restricted solubility in non hydrophilic solvents. Therefore, direct incorporation of PEI into higher order structures is a limited route as compared to the PFO approach of this invention.

The preparation of an AB block copolymer illustrates the PFO polymerization, the coupling to a B segment and the hydrolysis of the PFO to PEI (A segment). In this particular case the A-B block copolymer is made by sequential cationic polymerization of two oxazoline monomers to create poly(2-heptafluoropropyloxazoline)-poly(2-ethyloxazoline) PF₃O-PEO. The block 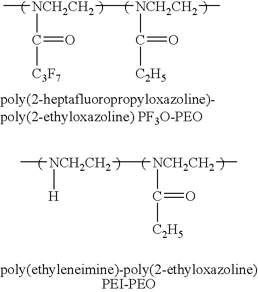
copolymer preparation is carried out in four discreet steps as illustrated in the following example. 1) initiation of the 2-heptafluoropropyloxazoline monomer with an alkylating agent such as ethyl trifluoromethanesulfonate such that X is an ethyl group, 2) cationic polymerization of the 2-heptafluoropropyloxazoline monomer to a degree of polymerization m, 3) continuation of polymerization with 2-ethyloxazoline monomer to create the B segment, 4) termination of the growing chain with a nucleophile such as propylamine. The polymerization of the 2-ethyloxazoline monomer in step 3 can be carried out even in the presence of unreacted 2-heptafluoropropyloxazoline monomer owing to its vastly greater nucleophilicity.

The length of the two blocks can be controlled by a combination of monomer to initiator concentration and by the reaction conversion. In a typical polymerization, a F₃O/initiator ratio of 30 and a conversion of 40% was estimated to give an PF₃O block length (m) of about 13. The estimated B block length of PEO was 49 based on an EO/initiator ratio of 61 and conversion of 83%. However, it should be noted that a portion of the EO monomer polymerizes free of the PF₃O-PEO block resulting in a shorter than estimated PEO length. Furthermore, the unattached PEO B block is removed from the PF₃O-PEO block by a water rinse step. The PF₃O-PEO block is water insoluble while the free PEO block and some of the shorter PF₃O blocks dissolve in the water and are removed. The final PF₃O-PEO block of the above example is estimated to have m of 17 and a B block length of 38 based on compositional analysis and molecular weight measurement.

Selective hydrolysis of the PF₃O can be carried out under mild condition with any of a variety of bases. The trifluoroacetly group is a well known protecting group for amines and is often used in protein chemistry. The result is a PEI-PEO block copolymer of segment lengths of 17 and 38.

Any of a broad range of B block oxazoline monomers can be used in this invention. In addition to an ethyl group as the oxazoline substituent described above for PEO, any substituent that does not interfere with the cationic polymerization and does not react under the conditions of the PFO hydrolysis is acceptable. These include but are not limited to hydrogen, alkyl or aryl groups. Additional groups may be attached to the alkyl or aryl groups to create additional functionality. For example, perfluoro groups spaced from the oxazoline ring by a non fluorinated substituent such as a methylene group would bring enhanced hydrophobicity to the B block. Alternatively, a hydroxyethyl group could be used to used to enhance the hydrophilicity of the B block. It should be noted that the strongly electron withdrawing nature of the A block monomer enables the A block hydrolysis to be carried out selectively in the presence of the B block. B block substituents are chosen to maintain this advantage.

The B segment is not limited to oxazoline monomers and is not limited to sequential cationic polymerization and is not limited to the diblock architecture. The B block may be derived from any chain that contains a reactive nucleophile end group that can attack the terminal group of the PFO polymerization. The amine terminated polyether Jefamine would lead to a PFO-polyether block followed by a PEI-polyether block after hydrolysis. In addition, chains with nucleophiles such as amines at both ends would enable PFO-B-PFO and PEI-B-PEI triblock copolymers. Examples include amine capped polyethers, polysiloxanes, polyesters, polyamides, polyurethanes and the like. The B block may be multifunctional in that it contains multiple nucleophilic sites along its backbone and chain ends. These would include vinyl copolymers where one of the comonomers contains an amine such as p-aminostyrene or an amino substituted acrylate. In addition, polypeptides, gelatin as well as cellulosics that have been amine functionalized would provide sites for attachment of PFO segments. Multiple attachments of PFO to a B chain would create PFO graft or star copolymers and PEI graft or star copolymers after hydrolysis. In this case of a graft copolymer the B chain is described as G*-G.

Higher order structures may also be made by initiation of PFO polymerization with a B segment. Incorporation of electrophilic sites into the B block would enable the PFO polymerization to be initiated off of the B block. These PFO segments could in turn be terminated with any of chemistries described here to create even higher order structures.

The PFO polymerization may also be terminated with functional groups that would allow for alternative incorporation chemistries beyond nucleophilic attach on the oxazoline ring. These approaches may be more convenient or versatile than introducing the B segment immediately at the end of the PFO polymerization as described above. Terminal functional groups that would allow for subsequent building of higher order structures include a polymerizable group such as a methacrylate or a chain transfer agent such as a thiol or any of a broad range of reactive groups such as amino, hydroxyl, carboxylic acid, epoxy and the like.

PFO polymerization terminated with the L group 2-(butylamino)ethanethiol can create a PFO with a terminal thiol. It is well known that thiols can be 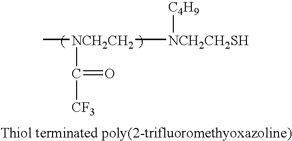
incorporated onto the ends of vinyl polymers by chain transfer polymerization. A thiol terminated PFO would enable blocks of the form:

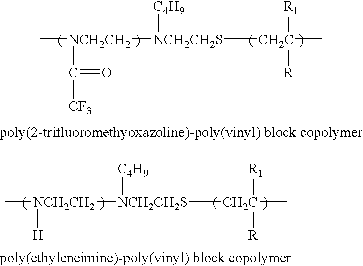

Thiols are not the only end groups that could serve as starting points for vinyl polymerization. A PFO could be terminated with the appropriate L end group to allow for vinyl polymerization by ATRP or by nitroxide mediated polymerizations.

A PFO containing a methacrylate end group as a G* group for subsequent vinyl copolymerization with a G vinyl monomer is yet another incorporation approach. A methacrylate monomer containing a nucleophilic group for attachment to the PFO end would be suitable. Many such vinyl monomers could be made. The following MEC example is described here wherein the iminoether functionality connects to the chain end as a substituted amide (L′) and the methacrylate group (G*) is suitable for copolymerization with other vinyl monomers.

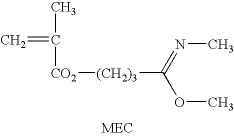

Vinyl copolymerization of a methacrylate terminated PFO can create graft copolymers with PFO side chains. Subsequent hydrolysis would lead to graft copolymers with PEI side chains.

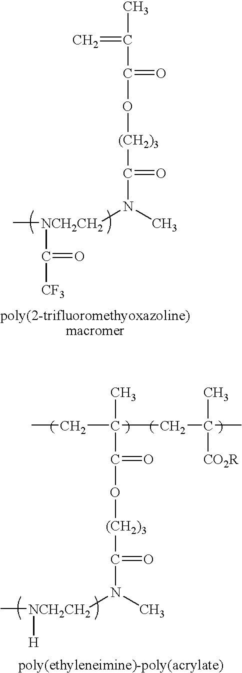

The following examples are provided to illustrate, but not to limit, the invention.

### EXAMPLES

### Example 1

### Preparation of F₁O

A 4-L erlenmeyer flask was charged with ethyltrifluoroacetate (1000 g, 7.03 m), 2-bromoethylamine hydrobromide (1,400 g, 6.83 m) and anhydrous ethanol (800 ml). The mixture was stirred as diisopropylethylamine (1050 g, 8.13 m) was added over 10 minutes. The reaction was mildly exothermic. The flask was cooled by an ice bath for 10 minutes and then left at room temperature overnight. The mixture was added to 9 liters of ice water containing 200 ml of 10N hydrochloric acid, the precipitate was filtered, dissolved in ether while still wet, washed with 500 ml of 0.5N hydrochloric acid and washed twice with 400 ml of saturated sodium chloride solution. After drying over magnesium sulfate, the solution was filtered, stripped of ether, and the product distilled under aspirator pressure at 100 to 105° C. The yield of 2-bromoethyl trifluoroacetamide was 952 g, 63%.

A 3-L 3 neck round bottom flask fitted with a mechanical stirrer and distillation apparatus was charged with anhydrous potassium carbonate (717 g, 5.2 moles), water (740 ml), tetra n-butyl ammonium bromide (2 g) and liquid 2-bromoethyl trifluoroacetamide which had been warmed at 70° C. The stirred mixture was heated until a water azeotrope distilled at 85° C. The collection flask was cooled with an ice water bath. The bottom layer of the two layer distillate was dried over anhydrous magnesium sulfate (483 g, 80%), filtered, and distilled from calcium hydride (105° C.). Further purification was carried out to remove a trace of diisopropylethylamine and to dry the monomer for polymerization. The monomer was taken up in 500 ml dichloromethane and washed twice with 150 ml 0.2N hydrochloric acid, twice with 150 ml water, dried over magnesium sulfate, isolated and redistilled. The monomer was subsequently distilled (105 C) from calcium hydride and then from sodium.

### Example 2

### Preparation of F₃O

A 3-necked 2-liter round bottomed flask fitted with a mechanical stirrer and a dropping funnel was charged with methyl heptafluorobutyrate (200 g, 0.877 m), 2-bromoethylamine hydrobromide (179.7 g, 0.877 m) and anhydrous methanol (500 ml). Diisopropylethylamine (115.7 g, 0.877 mol, was added dropwise over a period of an hour with stirring. The reaction mixture was stirred an additional hour, the methanol was removed by distillation and the reaction mixture was poured with stirring into 1500 ml of ice water containing 50 ml of concentrated hydrochloric acid. The white precipitate was filtered, washed with 1500 ml of ice water, dissolved in methylene chloride and washed twice with 150 ml 10% hydrochloric acid, twice with 150 ml of water and then dried over magnesium sulfate. The solution was rotary evaporated to give 243.1 g (87% yield) of a white crystalline solid, m.p. 64.5-65.5 C, Analysis calcd. for C6H4NOBrF7: C, 22.59; H, 1.26; N, 4.39. Found: C, 22.70; H, 1.62; N, 4.36.

A 250 ml one-neck round bottom flask fitted with a mechanical stirrer was charged with of N-(2-bromoethyl)heptafluorobutyramide (80.0 g, 0.25 in), of anhydrous potassium carbonate (41.6 g, 0.30 m), tetra n-butyl ammonium bromide (1.6 g, 0.005 m, 2%) and 50 ml of distilled water. The flask was slowly heated to 150 C. The product began to azeotrope at 132 C. The lower layer of the distillate was collected and dried over magnesium sulfate to give 52.5 g (b.p. 136-139 C, 88% yield). The monomer was distilled from calcium hydride immediately before polymerization.

### Example 3

### Preparation of PF₁O-PEO Block Copolymer

EO was distilled from calcium hydride, DMAc was anhydrous grade from Aldrich. An argon blanketed oven dried flask was charged with F₁O (67.8 g, 488 mmole), ethyl trifluoromethanesulfonate (0.93 g, 5.2 mmole) and stirred at 30 C for 75 minutes as the viscosity gradually increased to that of an oil. A sample was removed, quenched with water and analyzed by size exclusion chromatography and gas chromatography for molecular weight (Mn=5,780, Mw=6,560, mwd=1.13) and conversion (33%). The estimated PF₁O degree of polymerization was 31 based on monomer to initiator ratio and conversion. An initial charge of EO (6.3 g) was then added to convert the growing chain from a F₁O unit to an EO unit. Thereafter, a total of 49.4 g (498 mmole) of EO and 4.4 g of DMAc were added over 2.5 hours at room temperature followed by 1 hour of heating at 80 C. The polymerization was quenched at 83% EO conversion (the F₁O conversion had not increased since the EO addition showing that EO dominates the second stage polymerization) by adding 100 ml of acetone and 3 ml of water followed by 5 ml of diisopropylethylamine. The polymer was isolated as a white powder after precipitation into 21 of ether. The yield was 64 g in good agreement with the calculated yield of 63 g based on F₁O and EO conversion. The GPC was bimodal indicating some free PEO polymer mixed in with the PF₁O-PEO block.

The mixture (58.3 g) was extracted with 600 ml of water for 5 hours followed by centrifugation. The process was repeated. A total of 10 g of water soluble polymer was removed (83% recovery). The estimated copolymer composition after removal of 10 g of PEO was 44 wt % PF₁O in good agreement with 47 wt % by fluorine analysis (19.2%) and 48 wt % by NMR. The calculated PEO block length was 49 based on a dp of 31 for the PF₁O block and a 39/61 m/m composition. The final GPC Mn=10,200, Mw=11,800, mwd=1.16 was not inconsistent with block lengths of 4,310 (31) and 4,860 (49) or a total of 9,170

### Example 4

### Preparation of PF₃O-PEO Block Copolymer

EO was distilled from calcium hydride, acetonitrile was anhydrous grade from Aldrich. An argon blanketed oven dried flask was charged with F₃O (9.38 g, 39.3 mmole), ethyl trifluoromethanesulfonate (0.24 g, 1.3 mmole) and stirred at 35 C for 1 hour as the viscosity gradually increased to that of an oil. A sample was removed, quenched with water and analyzed by size exclusion chromatography and gas chromatography for molecular weight (Mn=4,060, Mw=5,090, mwd=1.25) and conversion (44%). The estimated PF₃O degree of polymerization was 13 based on monomer to initiator ratio and conversion. EO (7.91 g, 79.8 mmole) was then added to convert the growing chain from a F₃O unit to an EO unit. Thereafter, 3.5 g of acetonitrile was added and the solution was heated at 77 C for 2 hours. The polymerization was quenched at 83% EO conversion (the F₃O conversion had not increased since the EO addition showing that EO dominates the second stage polymerization) by adding propylamine (0.25 g, 4.2 mmole). The polymer was isolated as a white powder after precipitation into ether. The yield was 10.7 g in good agreement with the calculated yield of 11.2 g based on F₃O and EO conversion. The GPC was bimodal indicating some free PEO polymer mixed in with the PF₃O-PEO block. Water extraction and isolation by centrifugation resulted in a 70% recovery of monomodal (Mn=7,280, Mw=8,490, mwd=1.16) water insoluble fraction and 30% of a monomodal (Mn=3,880, Mw=4,740, mwd=1.22) water soluble fraction. The water insoluble fraction composition was 52/48 or 56.7/43.3 wt/wt and 31/69 m/m or 35/65 mm PF₃O/PEO based on fluorine analysis (28.8% or 31.55%?). The water soluble fraction was 5.1% fluorine indicating that some of the shorter PF₃O sequences were removed by the water. Assuming a slightly longer block length of 17 (vs. 13 calc) for the PF₃O block, the calculated PEO block length was 38 or 32. The final GPC Mn=7,280, Mw=8,490, mwd=1.17 was not inconsistent with block lengths of 4,060 (17) and 3,770 (38) or a total of 7,830.

### Example 5

### Hydrolysis of PF₁O-PEO to PEI-PEO

PF₁O-PEO block copolymer (2.5 g, 1.18 g PF₁O, 8.5 mmole, 1.32 g PEO) was dissolved in a mixture of DMAc (14.8 g) and water (4.7 g) and treated in five increments over two hours with a solution of tetramethylammonium hydroxide (2.0 g, 11 mmole) dissolved in DMAc (10.1 g) and water (3.2 g). The solution was warmed to 50 C for 5 minutes, diluted with water and dialyzed in a 1,000 mwco bag for 24 hours. The isolated yield after freeze drying was 1.52 g vs. a calculated yield of 1.68 g for PEI-PEO. The molecular weight by decrease by GPC was consistent with the calculated molecular weight change for a copolymer with block lengths of 31 and 49.

TABLE I
Calculated and Measured Molecular Weights Before and After
Deblocking.

| | Calculated | GPC (Mn and mwd) |
|---|---|---|
| PF₁O | 4,310 | 5,780 (1.13) |
| PF₁O-PEO | 9,170 | 11,850 (1.08) |
| PEI-PEO | 6,190 | 7,360 (1.20) |

### Example 6

### Hydrolysis of PF₃O-PEO to PEI-PEO

PF₃O-PEO block copolymer (4.02 g, 2.21 g PF₃O, 9.3 mmole, 1.81 g PEO) was dissolved in a mixture of THF (10.7 g) and acetonitrile (10.2 g) and treated with propionic anhydride (0.6 g) to acylate amine end groups formed by the propylamine termination. The solution was treated with methanol (10 g) and a tetramethyammonium hydroxide methanol solution (25%, 11 g, 30 mmole) and heated 30 minutes at 50 C. The clear solution was stripped of solvent, treated with water (3 ml) and another increment of tetramethyammonium hydroxide methanol solution (25%, 11 g, 30 mmole), heated 20 minutes and left at room temperature for 16 hours. The solution was diluted with water (20 ml), stripped of solvents, diluted with more water (45 ml) and dialyzed in a 500 mwco bag. The yield after freeze drying was 1.41 g vs. a calculated yield of 2.21 g or 2.15 g for 55-35 wt or 57-33 PEI-PEO. The molecular weight by decrease by GPC was consistent with the calculated molecular weight change for a copolymer with block lengths of xx and yy.

TABLE II
Calculated and Measured Molecular Weights Before and After
Deblocking.

| | Calculated | GPC (Mn and mwd) |
|---|---|---|
| PF₃O | 4,060 | 4,060 (1.25) |
| PF₃O-PEO | 7,830 | 7,280 (1.16) |
| PEI-PEO | 4,500 | 5,190 (1.17) |

### Example 7

### Preparation of MEC

An aqueous solution of methylamine (40%, 500 g, 6.44 m) in DCM (0.5 L) was cooled to 10-15° C. in a 3-neck 3-L round bottom flask fitted with a mechanical stirrer. Chlorobutyryl chloride in DCM (0.5 L) was added over 30 minutes. The mixture was diluted with DCM (300 ml), washed with 50/50 brine/water (500 ml) and dried over magnesium sulfate. The solution was filtered, stripped and the product was short path distilled at aspirator pressure (Kugelrohr). The product solidified as it cooled to give 228 g (84.2%).

4-Chloro-N-methyl butyramide (17.6 g, 130 mmol) and tetraxxammonium methacrylate (65 g, 155 mmol) were dissolved in DMAc and heated at 60° C. for 5 hours. The DMAc was removed by distillation at reduced pressure (0.1 mm). The product was dissolved in DCM (250 ml), the solution was washed with 50/50 brine/H₂O. dried over MgSO₄, filtered and stripped to yield 21 g. Distillation (0.06 mm, 125-135° C.) gave 6.5 g. Analysis calcd: C, 58.36; H, 8.16; N, 7.56. Found: C, 54.76; H, 7.79; N, 7.54.

A 60-mL septum vial was charged with 4-methacrylyl-N-methyl butyramide (6.05 g, 32.7 mmol) and DCM (38.6 g). Methyl triflate (5.37 g, 32.7 mmol) was then added and allowed to react for 3 hours. The solution was added to dimethylethyl amine (2.87 g, 39.2 mmol) in DCM (32 g). A slight exotherm occurred. The solution was washed with twice with water and once with brine, dried over magnesium sulfate, filtered and stripped of DCM. Distillation (0.08 mm, 62 to 68 C) yielded 4 g. A second distillation from calcium hydride yielded 3.6 g.

### Example 8

### Preparation of PF₁O Methacrylate Macromer

An argon blanketed oven dried 1 L flask fitted with a mechanical stirrer was charged with F₁O (324 g, 2.3 m), ethyl trifluoromethanesulfonate (2.17 g, 12.2 mmole) and stirred at 30 C for 2 hours as the viscosity gradually increased to that of an oil. The conversion reached 44%. MEC endcapper (7.0 g, 35 mmole) dissolved in F₁O (5 g) was added, the solution was heated at 45 C for 5 minutes and left 1 hour at room temperature. Triethylamine (8.2 g, 82 mmole) was added and the solution was heated at 45 C for 5 minutes. The polymer was isolated by precipitation in ether (1 L), reprecipitated in methanol (2 L) from acetone (300 ml) to yield 146 g of white powder, (45%), reprecipitated in 50/50 methanol/water (2 L) from acetone (350 ml) and finally reprecipitated in water (2 L) from acetone (400 ml) to yield 125 g. The calculated degree of polymerization was 83 (from conversion and monomer to initiator ratio) in fair agreement with ¹H-NMR analysis of one vinyl per 94 repeat units. GPC (Mn=17,200, Mw=18,700, mwd=1.09) gave a very approximate degree of polymerization of 122.

### Example 9

### Preparation of PF₁ O Graft

A vial was charged with ethyl maleimide (0.64 g, 5.1 mmole), 2-ethoxyethyl methacrylate (0.81 g, 5.1 mmole), MEK (3.6 g) and AIBN initiator (0.015 g). Half of the monomer solution was added to PF₁O macromer (0.298 g), purged with argon and heated at 80 C for 1 hour. The remaining monomer was then added and polymerization was continued for 1.75 hours. A comparison polymerization was carried out with the same components but no macromer. Monomer conversions were greater than 95% by gas chromatography.

GPC analysis was used to show that the free macromer was no longer present and that it had therefore incorporated into the polymer. Free macromer was added to the polymer of the comparison polymerization mixed and was identified by GPC analysis as shoulder in the GPC trace. The absence of the shoulder in the sample where the macromer was copolymerized with the monomers indicated that it had incorporated as a graft.

### Example 10

### Preparation of PF₁O Thiol Chain Transfer Agent

An argon blanketed vial was charged with F₁O (15 g, 108 mmole), ethyl trifluoromethanesulfonate (11.0 g, 5.6 mmole) and stirred at 30 C for 30 minutes as the viscosity gradually increased to that of an oil. N-butyl-2-aminoethylthiol (1.0 g, 7.5 mmole) was added to terminate the polymerization at 27% conversion. The mixture was precipitated in water/methanol (3/1), the oil was dissolved in methanol and reprecipitated by the addition of 2× ice. The solid was centrifuged and slurried with a mixture if ice and methanol, filtered and air dried to yield 3.6 g. The estimated degree of polymerization was 5. The oligomer was redissolved in DCM, washed with 5% sodium carbonate, water, dried with magnesium sulfate, filtered stripped of solvent to give 3.2 g.

1. A polymer represented by either Structure I or Structure II:
X [symbol] (NHCH₂CH₂)ₘ-Lᵣ-B]_{S} Structure I
wherein m is independently 2 to 500;
X is an initiating group;
B is independently a polymer or copolymer segment, wherein B is not poly(2-ethyloxazoline) (PEO) if its molecular weight is greater than 2,500 and B is connected to the PEI segment (NHCH2CH2)m either directly (r=0) at the end of the chain or via a linking group (r=1) at the end of the chain;
L is independently a linking group;
r is 0 or 1; and
s is 1 to 8; 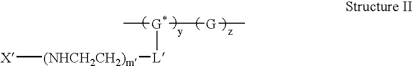
wherein m′ is independently 2 to 500;
X′ is independently an initiating group
L′ is independently a linking group linking the end of the chain of the PEI segment (NHCH2CH2)m′ to G*;
G is independently a polymerizable monomer;
G* is a monomer unit that is copolymerizable with the G monomer;
y+z is from 10 to 100,000; and
0<y/z<=1.

2. The polymer of claim 1 wherein X or X′ is an alkyl group, a multifunctional alkyl group of functionality from 1 to 8 or a perfluoroalkyl group.

3. The polymer of claim 1 wherein s is 1.

4. The polymer of claim 1 wherein B is a vinyl polymer and L has a functionality suitable for attaching to the end of a vinyl polymerization.

5. The polymer of claim 4 wherein L has a thiol functionality suitable for attaching to the end of a vinyl polymer by chain transfer polymerization.

6. The polymer of claim 1 wherein s is 2; B is a condensation polymer and L has a functionality suitable for attaching to the end of a condensation polymer.

7. The polymer of claim 1 wherein G* has a vinyl group suitable for participating in the polymerization of G.

8. The polymer of claim 7 wherein L′ has a functionality suitable for attaching to G*.

9. The polymer of claim 8 wherein L′ is a substituted amide derived from the reaction of the chain end with an iminoether.

10. The polymer of claim 1 wherein m is 2 to 100.

11. The polymer of claim 1 wherein m′ is independently 2 to 100.

12. The polymer of claim 1 wherein the polymer is represented by Structure I.

13. The polymer of claim 1 wherein the polymer is represented by Structure II.

14. A method of preparing a polymer represented by Structure I comprising providing a precursor polymer represented by Structure III and selectively deblocking said precursor polymer by hydrolysis: 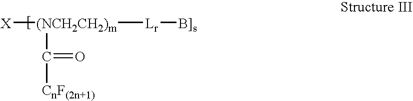
wherein m is independently 2 to 500;
X is an initiating group;
B is independently a polymer or copolymer segment, wherein B is not poly(2-ethyloxazoline) (PEO) if its molecular weight is greater than 2,500 and B is connected to the PEI precursor segment either directly (r=0) at the end of the chain or via a linking group (r=1) at the end of the chain;
L is independently a linking group;
r is 0 or 1; and
s is 1 to 8; and n is 1 to 7.

15. A method of preparing a polymer represented by Structure II comprising providing a precursor polymer represented by Structure IV and selectively deblocking said precursor polymer by hydrolysis: 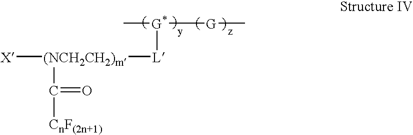
wherein m′ is independently 2 to 500;
X′ is independently an initiating group
L′ is independently a linking group connected to the end of the PEI precursor segment
G is independently a polymerizable monomer;
G* is a monomer unit that is copolymerizable with the G monomer;
y+z is from 10 to 100,000;
0<y/z<=1; and.
n is 1 to 7.
